(19) United States
(12) Patent Application Publication
(10) Pub. No.: US 2008/0121174 A1
(43) Pub. Date: May 29, 2008

(54) Pipe Joint Lubrication Device

(75) Inventor: Helge-Ruben Halse, Kristiansand S. (NO)

Correspondence Address: GABLE & GOTWALS, 100 WEST FIFTH STREET, 10TH FLOOR, TULSA, OK, 74103, US

(73) Assignee: V-TECH AS, KRISTIANSAND (NO)

(21) Appl. No.: 11/720,537

(22) PCT Filed: Dec. 14, 2005
(86) PCT No.: PCT/NO05/00461

§ 371 Date: May 31, 2007

(30) Foreign Application Priority Data
Dec. 16, 2004 (NO) 20045501

(51) Int. Cl. B05B 7/00

(52) U.S. Cl. 118/300

(57) ABSTRACT

A pipe joint lubrication device for application of lubricant on at least one of the fittings having a longitudinal axis, said device comprising a first nozzle on a first jaw housing which is rotatable about the longitudinal axis of the fitting wherein the first jaw housing, which is provided with an axial through opening, which forms part of a make-up tong of a power tong.

This invention regards a pipe joint lubrication device. More particularly, it regards a pipe joint lubrication device for lubrication of the threads of a pipe socket (socket) and of a pipe nipple (nipple). The lubricant is sprayed on while the nipple is rotated relative to the socket, the rotation taking place about the longitudinal axis of the socket and the nipple. The pipe joint lubrication device is particularly well suited for lubrication of the joints of a pipe string, such as is known from e.g. petroleum exploration and production.

It is customary when joining e.g. threaded drill pipes, to apply a lubricant (dope) on the threads, both in the socket and on the nipple. The purpose of the lubricant application is, in addition to facilitating the coupling and uncoupling of the pipes, to seal the threaded connection between the socket and the nipple when this is exposed to the relatively high fluid pressure encountered during drilling.

Previously it has been customary to apply the lubricant manually by means of e.g. a brush, However, mechanized lubricating apparatuses have been developed, in which the lubricant is sprayed onto the threads via nozzles, e.g. by use of compressed air.

Mechanized lubricating apparatuses according to prior art comprise relatively complicated positioning mechanisms and often represent an obstacle to efficient coupling of pipe lengths, as the lubricating apparatus must be brought up to the coupling location for each lubricating operation.

The object of the invention is to remedy or at least reduce at least one of the disadvantages of prior art.

The object is achieved in accordance with the invention, by the characteristics given in the description below and in the following claims.

The invention is realized through a pipe joint lubrication device comprising at least one first nozzle for application of the lubricant on at least one of the fittings; a threaded nipple or a threaded socket, where the at least one first nozzle is arranged on a first (clamping) jaw housing which is rotatable about the longitudinal axis of the nipple or socket.

Preferably the at least one first nozzle is supplied with lubricant via a duct in a swivel ring that encircles the first jaw housing and is stationary relative to the first jaw housing.

Advantageously at least one second nozzle is provided on a second jaw housing which is stationary relative to the longitudinal axis of the nipple or the socket, the second nozzle being arranged to spray lubricant towards at least one of the fittings; the threaded nipple or the threaded socket, while the fitting rotates about its own longitudinal axis.

Most advantageously the first jaw housing forms part of the make-up tong of a power tong, while the second jaw housing forms part of the holding-up tong of the power tong.

Advantageously the power tong comprises a retractable spacing mandrel arranged to establish and maintain a desired distance between the make-up tong and the holding-up tong during the application of lubricant.

The pipe joint lubrication device of the invention is is particularly suitable in connection with a so-called closed power tong, where the power tong remains centered about the pipe string, also when the power tong is not in use.

The following describes a non-limiting example of a preferred embodiment illustrated in the accompanying drawing, in which:

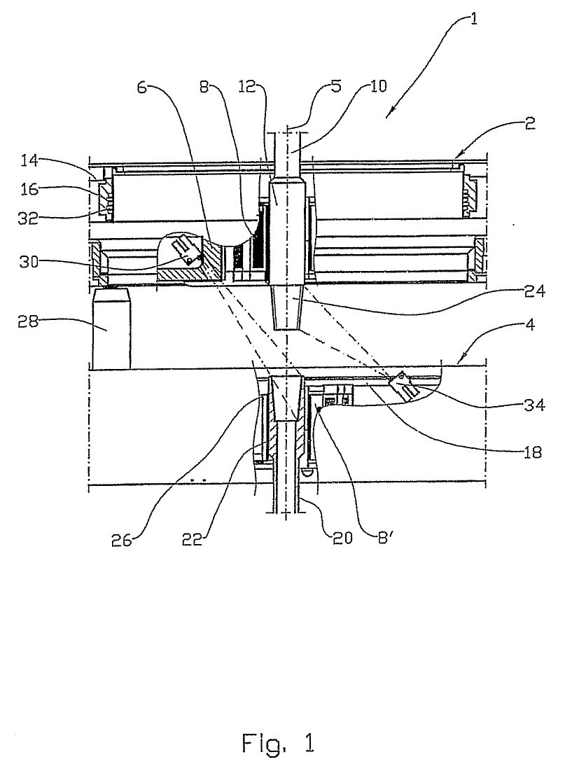

FIG. 1 shows a partially sectioned side view of the power tong as lubricant is being sprayed onto corresponding thread areas.

In the drawings, reference number 1 denotes a power tong comprising an upper make-up tong 2 and a lower holding-up tong 4. The make-up tong 2 and the holding-up tong 4 can be moved vertically by means of machine elements (not shown).

The make-up tong 2 is provided with a first jaw housing 6 which is rotatable about a vertical axis 5. The first jaw housing 6 comprises hydraulically operated clamping jaws 8 arranged to clamp around the lower end portion 12 of a pipe length 10.

The hydraulically operated clamping jaws 8 are supplied with pressurized fluid via ducts 14 in a swivel ring 16, the first jaw housing 6 being sealingly rotatable in the swivel ring 16. Other hydraulic connections required are not shown.

A second, rigidly mounted jaw housing 18 is located in the holding-up tong 4. Hydraulic clamping jaws 8′ in the second jaw housing 18 are arranged to grip the upper end portion 22 of a pipe string 20. The central axes of the pipe length 10 and the pipe string 20 at the power tong 1 generally correspond with the vertical central axis 5 of the power tong 1.

It is customary for the lower end portion 12 of the pipe length 10 to be provided with a threaded nipple 24, and for the upper end portion 22 of the pipe string 20 to be provided with a threaded socket 26, as shown in the example of embodiment.

The holding-up tong 4 is provided with a retractable spacing mandrel 28 arranged to establish and maintain a specified vertical spacing between the make-up tong 2 and the holding-up tong 4.

A first nozzle 30 is provided in the first jaw housing 6 and is supplied with lubricant and compressed air via ducts 32 in the swivel ring 16. Thus, the nozzle 30 is designed to spray lubricant towards the threaded socket 26 while rotating about the axis 5.

A second nozzle 34 is provided in the second jaw housing 18 and is arranged to spray lubricant towards the threaded nipple 24. If the threaded nipple 24 is rotated about the axis 5, the lubricant is distributed around the nipple 24.

With the exception of ducts 32, feed pipes for lubricant and compressed air to the nozzles 30 and 34 are not shown.

When the upper socket of the pipe string 20 is fastened and stationary in the holding-up tong 4 while the nipple 24 on the pipe length 10 is fastened and rotates about the axis 5 in the make-up tong 2, and the socket 26 and the nipple 24 are at an appropriate level relative to the power tong 1, both the socket 26 and the nipple 24 may be lubricated is simultaneously by nozzles 30 and 32.

1. (canceled)

2. (canceled)

3. (canceled)

4. (canceled)

5. (canceled)

6. A pipe joint lubrication device for application of lubricant on a fitting having a longitudinal axis, said device comprising a first nozzle on a first jaw housing which is rotatable about the longitudinal axis of the fitting wherein the first jaw housing, is provided with an axial through opening, which forms part of a make-up tong of a power tong.

7. The pipe joint lubrication device in accordance with claim 6, further comprising the one first nozzle is supplied with lubricant via a duct in a swivel ring that encircles the first jaw housing and is stationary relative to the first jaw housing.

8. The pipe joint lubrication device in accordance with claim 6, further comprising a second nozzle placed on a second jaw housing which is stationary relative to the longitudinal axis of the fitting, the second nozzle being arranged to spray lubricant towards the fitting; while the fitting rotates about its own longitudinal axis.

9. The pipe joint lubrication device in accordance with claim 8, wherein the second jaw housing forms part of a holding-up tong of the power tong.

10. The pipe joint lubrication device in accordance with claim 9, wherein the power tong comprises a retractable spacing mandrel arranged to establish and maintain a desired distance between the make-up tong and the holding-up tong during the application of lubricant.

11. The pipe joint lubrication device in accordance with claim 6, wherein the fitting is comprising a nipple.

12. The pipe joint lubrication device in accordance with claim 6, wherein the fitting is comprising a threaded socket.
